(19) United States
(12) Patent Application Publication
(10) Pub. No.: US 2025/0291345 A1
(43) Pub. Date: Sep. 18, 2025

(54) CHARGING STATION MANAGEMENT SYSTEM AND MANAGEMENT METHOD THEREOF

(71) Applicant: LITE-ON SINGAPORE PTE LTD., Singapore (SG)

(72) Inventors: Ken-Weng KOW, Singapore (SG); En Cheng Benjin Lau, Singapore (SG); Jen-Ruey Ng, Singapore (SG); Siong-Hin Gan, Singapore (SG)

(21) Appl. No.: 18/793,986

(22) Filed: Aug. 5, 2024

Related U.S. Application Data
(60) Provisional application No. 63/565,011, filed on Mar. 14, 2024.

(30) Foreign Application Priority Data
Jun. 27, 2024 (CN) 202410850059.3

(51) Int. Cl. G05B 23/02

(52) U.S. Cl. CPC G05B 23/0259

(57) ABSTRACT

A charging station management system includes a connection port, a remote server and a status database. The connection port is connected to at least one charging station through a network interface. The remote server is connected to the connection port for remotely managing the charging station to support an open charge point protocol service. The status database is configured to record the status of the charging station. When a fault event occurs at the charging station, the remote server receives a fault information from the charging station to update the status of the charging station, and retrieves a troubleshooting guidance information based on the fault information to support a charging station troubleshooting service.

This application claims the benefits of U.S. provisional application Ser. No. 63/565,011, filed Mar. 14, 2024 and People's Republic of China application Serial No. 202410850059.3, filed Jun. 27, 2024, the subject matter of which is incorporated herein by reference.

### BACKGROUND OF THE INVENTION

### Field of the Invention

The invention relates in general to a charging station management system, and more particularly to an electric vehicle charging station management system and a management method thereof.

### Description of the Related Art

In recent years, with the rise of environmental awareness and the advancement of electric vehicle technology, the development of electric vehicles that use electric energy as a power source to replace traditional vehicles that use fossil fuels as a power source has gradually become an important goal in the automotive field. Therefore, it makes electric vehicles become more and more popular. In order to improve the range and willingness to use electric vehicles, many countries or cities have begun to plan to set up charging stations to provide electricity to electric vehicles in public places. They have also begun to plan to deploy a large number of charging stations in urban areas or scenic spots to make charging of electric vehicles more convenient.

Since charging stations are deployed in various places and have different specifications, when a charging station fails, maintenance personnel cannot be notified immediately. Therefore, there is a problem that maintenance personnel cannot immediately perform troubleshooting after a charging station fails.

### SUMMARY OF THE INVENTION

The present invention relates to a charging station management system and a management method thereof, which can remotely manage charging stations, and when a charging station fails, can receive fault information from the charging station through a remote server, so as to perform a charging station troubleshooting service.

According to one aspect of the present invention, a charging station management system including a connection port, a remote server and a status database is provided. The connection port is connected between a charging station and the remote server. The remote server is used to remotely manage the charging station to support an open charge point protocol service. The status database is used to record the status of the charging station. When a fault event occurs at the charging station, the remote server receives a fault information from the charging station, updates the status of the charging station, and retrieves a troubleshooting guidance information based on the fault information to support a charging station troubleshooting service.

According to one aspect of the present invention, a charging station management method is provided. The method includes the following steps. a status of a charging station is shown through a web application that is connected to an open charge point protocol service application through a network interface to support an open charge point protocol service. When the status of the charging station changes, the charging station transmits the status of the charging station to the open charge point protocol service application, and the open charge point protocol service application notifies an event stream processing platform to process a message that the status of the charging station changes, and transmits the message to a charging station service application. The status of the charging station is updated in a status database by the charging station service application.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 is a schematic diagram of a charging station management system according to an embodiment of the present invention.

FIG. 2 is a schematic diagram illustrating an operation method of a charging station management system according to an embodiment of the present invention.

FIG. 3 is a flow chart of a charging station management method according to an embodiment of the present invention.

### DETAILED DESCRIPTION OF THE INVENTION

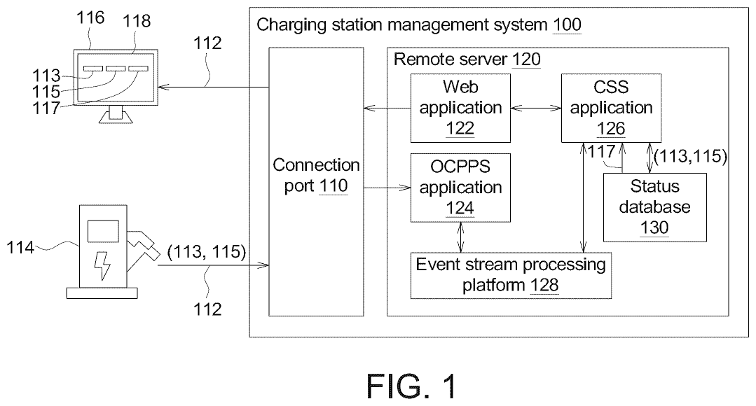

Referring to FIG. 1, a schematic diagram of a charging station management system 100 according to an embodiment of the present invention is shown. The charging station management system 100 is used to manage an electric vehicle charging equipment, such as a fast charging/slow charging station, a DC charging station, an AC charging station, etc. The above-mentioned charging stations can be set up in residences, community buildings, parking lots, shopping malls or scenic spots, etc., and can provide electric vehicles with charging operations.

Referring to FIG. 1, the charging station management system 100 includes a connection port 110, a remote server 120 and a status database 130. The connection port 110 is connected to at least one charging station 114 through a network interface 112. That is to say, the network interface 112 is connected between the charging station 114 and the connection port 110. The number of charging stations 114 can be one or more, and the network interface 112 can be used to transmit signals. The remote server 120 is connected to the connection port 110 for remotely managing the charging station 114 to support an open charge point protocol service (OCPPS) and a charging station troubleshooting service (CSTS). The status database 130 is used to record the status 113 of the charging station 114 and related data.

The network interface 112 can be a wired network, a telecommunications network or a wireless network (such as a Wi-Fi network). The remote server 120 can receive various data from the charging station 114 through the network interface 112 and send relevant signals to the charging station 114. For example, when an electric vehicle is coupled to the charging station 114 through a charging gun of the charging station 114 to perform a charging operation, the charging station 114 can continue to transmit the charging information of the charging operation of the electric vehicle through the network interface 112. The remote server 120 can receive charging information corresponding to the charging operation of the electric vehicle through the network interface 112. The charging information includes charging time, charging power, and charging efficiency, etc.

In addition, when a fault event occurs in the charging station 114, the charging station 114 transmits a fault information 115 through the network interface 112, and the remote server 120 can receive the fault information 115 from the charging station 114 through the network interface 112. The fault information 115 may include the name of the faulty equipment, fault code, fault time, fault cause, and fault location, etc.

The name of the faulty device is a model of the charging station where the fault occurred, the fault code is a code of the cause of the fault, and the cause of the fault is a reference message of the fault code sent by the faulty equipment. In addition, the status 113 of the charging station 114 can display the charging information of the charging station 114 and the information that the charging station 114 is in use, fault, charging normally or charging abnormally. The status 113 and the fault information 115 of the charging station 114 can exist in a charging station signal at the same time. As long as the status 113 of the charging station 114 changes or fails, the charging station 114 will send a charging station signal to the remote server 120.

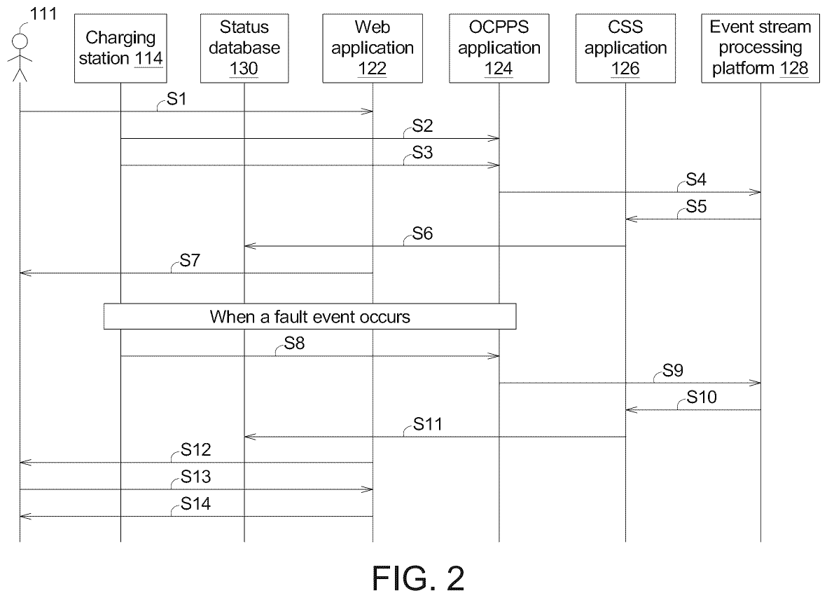

Referring to FIG. 1, the remote server 120 may include a web application 122, an open charge point protocol service (OCPPS) application 124, and a charging station service (CSS) application 126, and an event stream processing platform 128 (e.g., a cluster manager). The remote server 120 can communicate with the charging station 114 through the OCPPS application 124 to obtain the status 113 of the charging station 114. Additionally, the OCPPS application 124 may communicate with the CSS application 126 via the event stream processing platform 128 to update the status 113 of the charging station 114. In addition, the CSS application 126 can display the latest status (such as charging status or fault status) of the charging station 114 on a web page 118 through the web application 122 for maintenance personnel 111 (or inspection personnel) to check (see FIG. 2).

In one embodiment, when the event stream processing platform 128 receives the fault information 115 from the charging station 114, the charging station service (CSS) application 126 can retrieve a troubleshooting guidance information 117 for the fault information 115, and the web application 122 receives instructions from the charging station service (CSS) application 126 to display the status 113, the fault information 115 and the troubleshooting guidance information 117 of the charging station 114 on a web page 118 for on-site maintenance personnel 111 (or inspection personnel) log in to the website through the terminal device 116 (such as a computer or mobile phone) and view the web page 118, they can instantly check the status 113 of the charging station 114, and perform troubleshooting based on the fault information 115 and the troubleshooting guidance information 117.

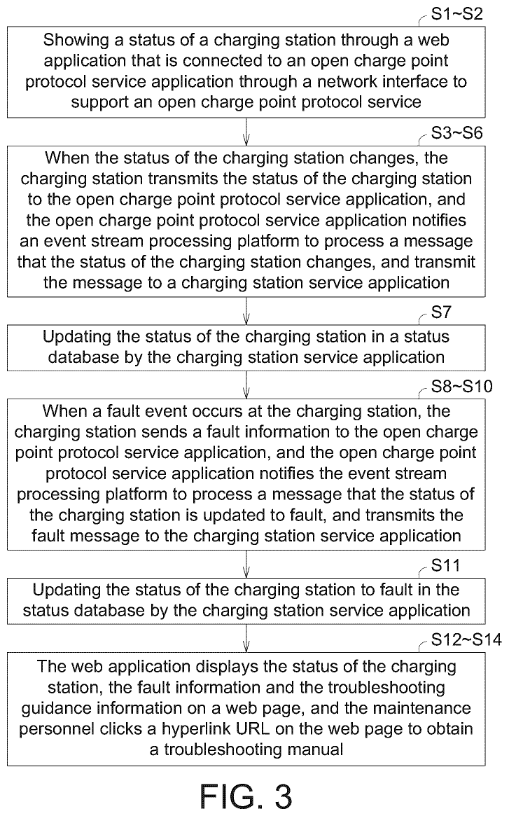

Referring to FIGS. 2 and 3, FIG. 2 illustrates a schematic diagram of an operating method of the charging station management system 100 according to an embodiment of the present invention, and FIG. 3 illustrates a flow chart of the charging station management method. First, in operation S1, the user can log in to the website set up by the charging station management system 100 and check the status 113 of the charging station 114 in real time through the web application 122. In operation S2, the charging station 114 can connect to the open charge point protocol service (OCPPS) application 124 through the network interface 112 to support an open charge point protocol service (OCPPS). In operation S3, when the status 113 of the charging station 114 changes, the charging station 114 transmits the status 113 of the charging station 114 to the open charge point protocol service (OCPPS) application 124 through the network interface 112. In operation S4, the open charge point protocol service (OCPPS) application 124 then transmits the status 113 of the charging station 114 to the event stream processing platform 128. In operation S5, the event stream processing platform 128 processes the information regarding the change of the state 113 of the charging station 114 and transmits the information to the charging station service (CSS) application 126.

Next, in operation S6, the charging station service (CSS) application 126 updates the status 113 of the charging station 114 and stores it in the status database 130. Therefore, in operation S7, the user can instantly check the latest status of the charging station 114 through the web application 122. At the same time, in operation S7, whenever the status 113 of the charging station 114 changes, the remote server 120 can use the subscription function in the GraphQL language to push the updated latest status from the remote server 120 to the web application 122.

Referring to FIGS. 2 and 3, in operation S8, when a fault event occurs at the charging station 114, the charging station 114 transmits a fault information 115 to the open charge point protocol service (OCPPS) application 124 through the network interface 112. In operation S9, the open charge point protocol service (OCPPS) application 124 then transmits the status 113 of the charging station 114 to the event stream processing platform 128 (e.g., a cluster manager). In operation S10, the event stream processing platform 128 processes the message that the status 113 of the charging station 114 is updated to a fault and transmits the fault message to the charging station service (CSS) application 126. Next, in operation S11, the charging station service (CSS) application 126 updates the status 113 of the charging station 114 to “fault” and stores the status 113 of the charging station 114 updated to “fault” in the status database 130. In addition, the charging station service (CSS) application 126 can retrieve a troubleshooting guidance information 117 based on the fault information 115 to support a charging station troubleshooting service.

Afterwards, in operation S12, the web application 122 can display the status 113, the fault information 115 and the troubleshooting guidance information 117 of the charging station 114 on a web page 118. Therefore, in operation S13, a user (e.g., a manager) can instantly view the status 113, the fault information 115 and the troubleshooting guidance information 117 of the charging station 114 through the web application 122. In addition, in operation S13, the on-site maintenance personnel 111 (or inspection personnel) can click a hyperlink uniform resource locator (URL) on the web page 118, and this hyperlink URL can be connected to a database in which a troubleshooting manual is pre-stored. In operation S14, the web application 122 obtains the troubleshooting manual from the database and transmits it to the on-site maintenance personnel 111 (or inspection personnel).

In one embodiment, the troubleshooting manual includes analysis steps for determining the fault cause and processing steps for eliminating the fault cause. Therefore, on-site maintenance personnel 111 (or inspection personnel) can perform maintenance according to the processing steps in the troubleshooting manual to improve work efficiency.

In one embodiment, the event stream processing platform 128 includes, for example, a graphical user interface to graphically display charging information, status information and other information of the charging station 114, as shown in Table 1.

TABLE 1

| | | | | Charging | Battery | | |
|---|---|---|---|---|---|---|---|
| | | Connector | Power | capacity | capacity | | |
| No. | Location | type | rate | (Wh) | of vehicle | Status | Message |
| charging | 01 | Type 1 | 2.7 kW | 1.7 kWh | 27% | charging | |
| station 1 | | | | | | | |
| charging | 02 | Type 1 | 2.7 kW | 1.7 kWh | 27% | charging | |
| station 2 | | | | | | | |
| charging | 03 | Type 1 | | | | fault | fault |
| station 3 | | | | | | | code |
| charging | 04 | Type 1 | | | | standby | |
| station 4 | | | | | | | |
| charging | 05 | Type 1 | | | | standby | |
| station 5 | | | | | | | |

Once the status 113 of the charging station 114 changes, the event stream processing platform 128 sends a message. The event stream processing platform 128 can be a Kafka cluster management tool for providing a web graphical user interface, allowing users to conveniently manage the Kafka cluster through the web graphical user interface. In addition, whenever the status 113 of the charging station 114 changes, the remote server 120 can use the subscription function in the GraphQL language to push the updated latest status from the remote server 120 to the web application 122.

In one embodiment, when the status 113 of the charging station 114 is “fault”, the web application 122 marks the charging station 114 as “fault” and displays the fault information 115 (such as a fault code) and the troubleshooting guidance information 117 (such as a hyperlink URL) on the web page 118, and the troubleshooting guidance information 117 includes a hyperlink URL for the maintenance personnel 111 to obtain the troubleshooting manual. The maintenance personnel 111 can obtain the troubleshooting manual by simply clicking on the hyperlink URL.

In one embodiment, the troubleshooting manual can be provided by the charging station manufacturer. The charging station maintenance personnel 111 store the troubleshooting manual in a network database and establish relevant hyperlinks to facilitate users to obtain the troubleshooting manual. Common fault causes of the charging station are as follows: (1) Charging gun connector lock failure. (2) The charging station communication is abnormal. (3) The charging station is grounded abnormally. (4) The temperature is too high. (5) Internal error. (6) Abnormal overcurrent. (7) Abnormal overvoltage. (8) The power meter is abnormal. (9) The power switch is abnormal. (10) Reader is abnormal. (11) Reset is abnormal. (12) The voltage is too low. (13) The signal is too weak. In one embodiment, when the fault cause of the charging station is excessive temperature, the web application 122 marks the charging station 114 as “fault” for maintenance personnel 111 to check. The maintenance personnel 111 can determine that the possible cause is a fan failure based on the processing methods in the troubleshooting manual, and replace the fan. In another embodiment, when the fault cause of the charging station is that the signal is too weak, the web application 122 marks the charging station 114 as “fault” for the maintenance personnel 111 to check. The maintenance personnel 111 can determine the possible causes according to the processing methods in the troubleshooting manual as the user identity module (SIM) card failure, poor signal transmission by the transmitter, or problems with the signal line, so that the maintenance personnel 111 can perform corresponding maintenance.

The charging station management system of the above embodiment of the present invention can remotely manage the charging station, and when a fault occurs at the charging station, the user can receive the fault information from the charging station through the remote server to perform a charging station troubleshooting service. Therefore, the users (such as managers) can instantly view the status, the fault information and the troubleshooting guidance information of the charging station through the web application. In addition, on-site maintenance personnel (or inspection personnel) can click on a hyperlink URL in the web page. This hyperlink URL can be connected to a database that stores a troubleshooting manual, so that on-site maintenance personnel (or inspection personnel) can obtain the troubleshooting manual quickly.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A charging station management system, comprising:
a connection port connected to at least one charging station through a network interface;
a remote server connected to the connection port, the remote server being used to remotely manage the charging station to support an open charge point protocol service; and
a status database used to record a status of the charging station,
wherein when a fault event occurs at the charging station, the remote server receives a fault information from the charging station to update the status of the charging station, and retrieves a troubleshooting guidance information based on the fault information to support a charging station troubleshooting service.

2. The charging station management system of claim 1, wherein the remote server comprises an open charge point protocol service application, and the remote server communicates with the charging station through the open charge point protocol service application.

3. The charging station management system of claim 2, wherein the remote server comprises an event stream processing platform, wherein when the status of the charging station changes, the open charge point protocol service application transmits the status of the charging station to the event stream processing platform.

4. The charging station management system of claim 3, wherein the remote server includes a charging station service application, and the open charge point protocol service application communicates with the charging station service application through the event stream processing platform to update the status of the charging station.

5. The charging station management system of claim 4, wherein when the status of the charging station is “fault”, the charging station service application updates the status of the charging station to “fault” and stores the status of the charging station updated to “fault” in the status database.

6. The charging station management system of claim 4, wherein the remote server comprises a web application that displays the status of the charging station, the fault information and the troubleshooting guidance information on a web page.

7. The charging station management system of claim 6, wherein when the status of the charging station is “fault”, the web application marks the charging station as “fault” and displays the fault information and the troubleshooting guidance information on the web page.

8. The charging station management system of claim 6, wherein the remote server uses a subscription function in GraphQL language to push a latest updated status of the charging station from the remote server to the web application.

9. The charging station management system of claim 3, wherein the event stream processing platform comprises a graphical user interface for displaying a charging information and the fault information of the charging station.

10. The charging station management system of claim 1, wherein the troubleshooting guidance information comprises a hyperlink URL for a maintenance personnel to obtain a troubleshooting manual.

11. A charging station management method, comprising:
showing a status of a charging station through a web application that is connected to an open charge point protocol service application through a network interface to support an open charge point protocol service;
when the status of the charging station changes, the charging station transmits the status of the charging station to the open charge point protocol service application, and the open charge point protocol service application notifies an event stream processing platform to process a message that the status of the charging station changes, and transmits the message to a charging station service application; and
updating the status of the charging station in a status database by the charging station service application.

12. The charging station management method of claim 11, wherein when a fault event occurs at the charging station, the charging station sends a fault information to the open charge point protocol service application, and the open charge point protocol service application notifies the event stream processing platform to process a message that the status of the charging station is updated to “fault”, and transmits the fault message to the charging station service application; and
updating the status of the charging station to “fault” in the status database by the charging station service application.

13. The charging station management method of claim 12, wherein the charging station service application retrieves a troubleshooting guidance information based on the fault information to support a charging station troubleshooting service.

14. The charging station management method of claim 13, wherein the web application displays the status of the charging station, the fault information and the troubleshooting guidance information on a web page.

15. The charging station management method of claim 13, wherein the troubleshooting guidance information comprises a hyperlink URL for a maintenance personnel to obtain a troubleshooting manual.
